(19) United States
(12) Patent Application Publication
(10) Pub. No.: US 2022/0284267 A1
(43) Pub. Date: Sep. 8, 2022

(54) ARCHITECTURES FOR TEMPORAL PROCESSING ASSOCIATED WITH WIRELESS TRANSMISSION OF ENCODED DATA

(71) Applicant: QUALCOMM Incorporated, San Diego, CA (US)

(72) Inventors: Pavan Kumar VITTHALADEVUNI, San Diego, CA (US); Taesang YOO, San Diego, CA (US); Naga BHUSHAN, San Diego, CA (US)

(21) Appl. No.: 17/193,974

(22) Filed: Mar. 5, 2021

(51) Int. Cl. G06N 3/04; H04B 7/06

(52) U.S. Cl. CPC G06N 3/0445; H04B 7/0626; G06N 3/049; G06N 3/0454

(57) ABSTRACT

Various aspects of the present disclosure generally relate to wireless communication. In some aspects, a transmitting wireless communication device may encode a data set using a single shot encoding operation and a temporal processing operation associated with at least one neural network to produce an encoded data set, wherein a dimensionality of a subset of inputs of a set of inputs to the temporal processing operation is greater than a dimensionality of the encoded data set. The transmitting wireless communication device may transmit the encoded data set to a receiving wireless communication device. Numerous other aspects are described.

### FIELD OF THE DISCLOSURE

Aspects of the present disclosure generally relate to wireless communication and to techniques and apparatuses for architectures for temporal processing associated with wireless transmission of encoded data.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a transmitting wireless communication device for wireless communication includes a memory and one or more processors, operatively coupled to the memory, configured to: encode a data set using a single shot encoding operation and a temporal processing operation associated with at least one neural network to produce an encoded data set, wherein a dimensionality of a subset of inputs of a set of inputs to the temporal processing operation is greater than a dimensionality of the encoded data set; and transmit the encoded data set to a receiving wireless communication device.

In some aspects, a receiving wireless communication device for wireless communication includes a memory and one or more processors, operatively coupled to the memory, configured to: receive an encoded data set from a transmitting wireless communication device; and decode the encoded data set using a single shot decoding operation and a temporal processing operation associated with at least one neural network to produce a decoded data set, wherein a dimensionality of a subset of inputs of a set of inputs to the temporal processing operation is less than a dimensionality of the decoded data set.

In some aspects, a method of wireless communication performed by a transmitting wireless communication device includes encoding a data set using a single shot encoding operation and a temporal processing operation associated with at least one neural network to produce an encoded data set, wherein a dimensionality of a subset of inputs of a set of inputs to the temporal processing operation is greater than a dimensionality of the encoded data set; and transmitting the encoded data set to a receiving wireless communication device.

In some aspects, a method of wireless communication performed by a receiving wireless communication device includes receiving an encoded data set from a transmitting wireless communication device; and decoding the encoded data set using a single shot decoding operation and a temporal processing operation associated with at least one neural network to produce a decoded data set, wherein a dimensionality of a subset of inputs of a set of inputs to the temporal processing operation is less than a dimensionality of the decoded data set.

In some aspects, a non-transitory computer-readable medium storing a set of instructions for wireless communication includes one or more instructions that, when executed by one or more processors of a transmitting wireless communication device, cause the transmitting wireless communication device to: encode a data set using a single shot encoding operation and a temporal processing operation associated with at least one neural network to produce an encoded data set, wherein a dimensionality of a subset of inputs of a set of inputs to the temporal processing operation is greater than a dimensionality of the encoded data set; and transmit the encoded data set to a receiving wireless communication device.

In some aspects, a non-transitory computer-readable medium storing a set of instructions for wireless communication includes one or more instructions that, when executed by one or more processors of a receiving wireless communication device, cause the receiving wireless communication device to: receive an encoded data set from a transmitting wireless communication device; and decode the encoded data set using a single shot decoding operation and a temporal processing operation associated with at least one neural network to produce a decoded data set, wherein a dimensionality of a subset of inputs of a set of inputs to the temporal processing operation is less than a dimensionality of the decoded data set.

In some aspects, an apparatus for wireless communication includes means for encoding a data set using a single shot encoding operation and a temporal processing operation associated with at least one neural network to produce an encoded data set, wherein a dimensionality of a subset of inputs of a set of inputs to the temporal processing operation is greater than a dimensionality of the encoded data set; and means for transmitting the encoded data set to a receiving wireless communication device.

In some aspects, an apparatus for wireless communication includes means for receiving an encoded data set from a transmitting wireless communication device; and means for decoding the encoded data set using a single shot decoding operation and a temporal processing operation associated with at least one neural network to produce a decoded data set, wherein a dimensionality of a subset of inputs of a set of inputs to the temporal processing operation is less than a dimensionality of the decoded data set.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, RF chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIG. 3 is a diagram illustrating an example of an encoding device and a decoding device that use previously stored channel state information (CSI), in accordance with the present disclosure.

FIG. 4 is a diagram illustrating an example of encoding and decoding a data set using a neural network for uplink communication, in accordance with the present disclosure.

FIGS. 5-12 are diagrams illustrating examples associated with architectures for temporal processing associated with wireless transmission of encoded data, in accordance with the present disclosure.

FIGS. 13 and 14 are diagrams illustrating example processes associated with architectures for temporal processing associated with wireless transmission of encoded data, in accordance with the present disclosure.

FIG. 15 is a block diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

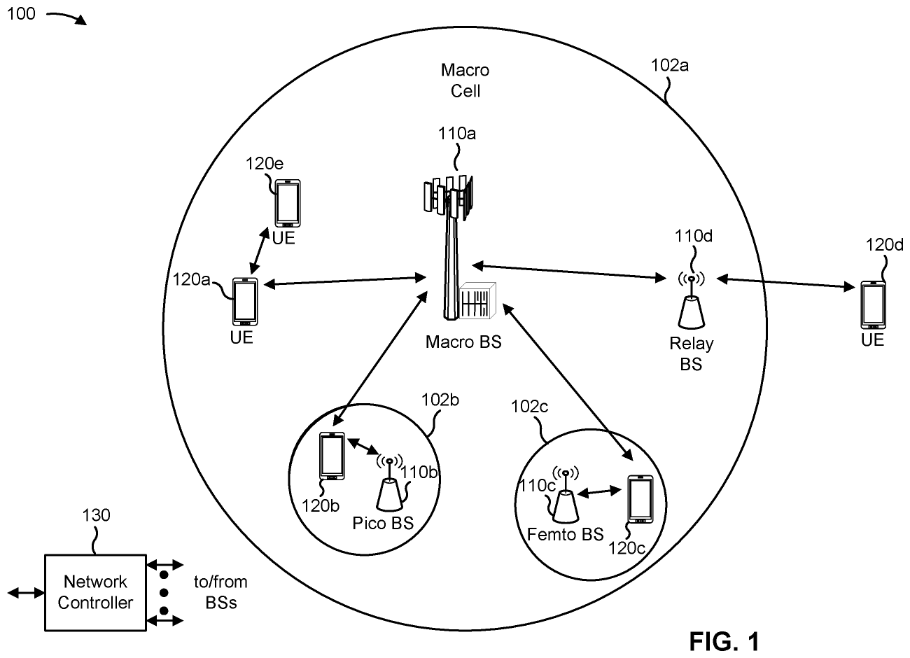

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

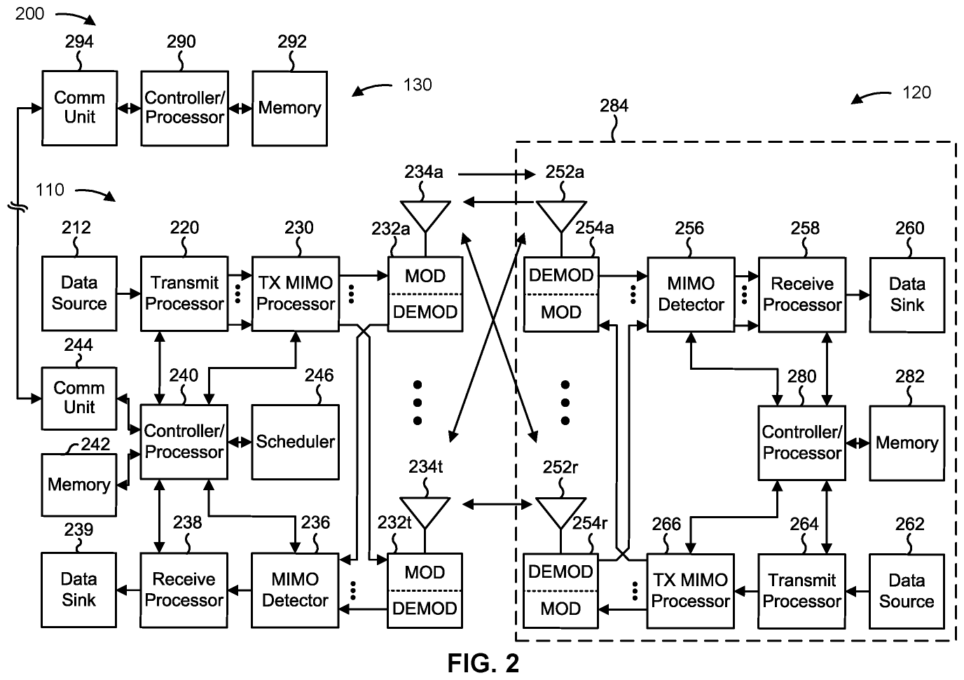

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

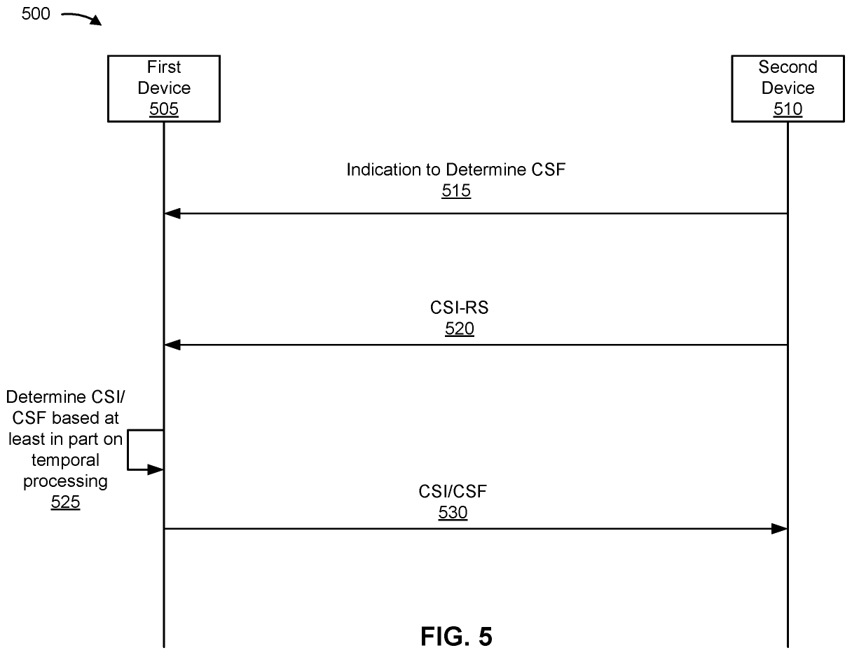

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 5-14).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 5-14).

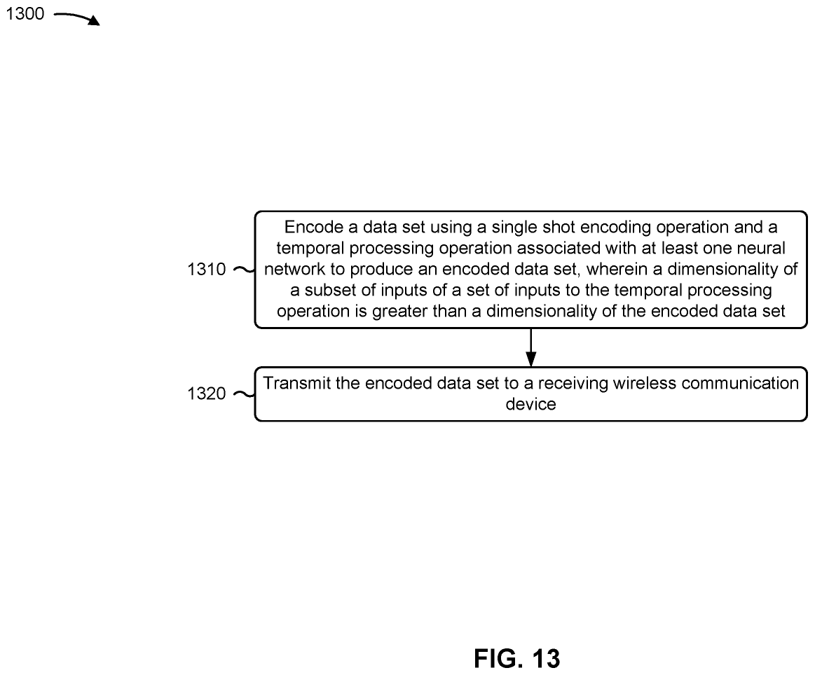

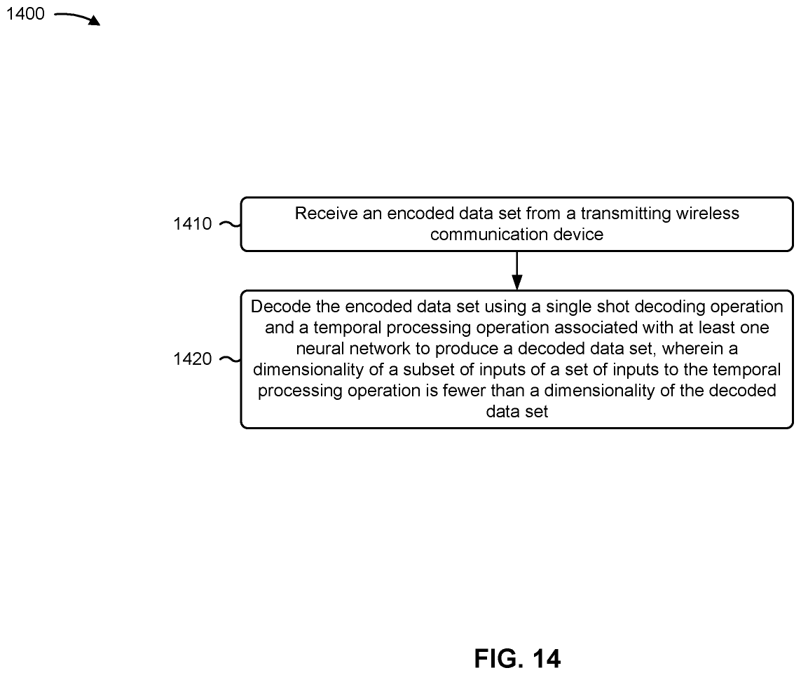

Controller/processor 240 of base station 110, controller/processor 280 of UE 120, and/or any other component(s) of FIG. 2 may perform one or more techniques associated with architectures for temporal processing associated with wireless transmission of encoded data, as described in more detail elsewhere herein. In some aspects, the wireless communication device described herein may be the base station 110, may be included in the base station 110, or may include one or more components of the base station 110 shown in FIG. 2. In some aspects, the wireless communication device described herein may be the UE 120, may be included in the UE 120, or may include one or more components of the UE 120 shown in FIG. 2. For example, controller/processor 240 of base station 110, controller/processor 280 of UE 120, and/or any other component(s) of FIG. 2 may perform or direct operations of, for example, process 1300 of FIG. 13, process 1400 of FIG. 14, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1300 of FIG. 13, process 1400 of FIG. 14, and/or other processes as described herein. In some aspects, executing instructions may include running the instructions, converting the instructions, compiling the instructions, and/or interpreting the instructions, among other examples.

In some aspects, the transmitting wireless communication device includes means for encoding a data set using a single shot encoding operation and a temporal processing operation associated with at least one neural network to produce an encoded data set, wherein a dimensionality of a subset of inputs of a set of inputs to the temporal processing operation is greater than a dimensionality of the encoded data set; and/or means for transmitting the encoded data set to a receiving wireless communication device. In some aspects, the means for the transmitting wireless communication device to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246. In some aspects, the means for the transmitting wireless communication device to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the transmitting wireless communication device includes means for transmitting channel state information feedback to the receiving wireless communication device.

In some aspects, the receiving wireless communication device includes means for receiving an encoded data set from a transmitting wireless communication device; and/or means for decoding the encoded data set using a single shot decoding operation and a temporal processing operation associated with at least one neural network to produce a decoded data set, wherein a dimensionality of a subset of inputs of a set of inputs to the temporal processing operation is less than a dimensionality of the decoded data set. In some aspects, the means for the receiving wireless communication device to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246. In some aspects, the means for the receiving wireless communication device to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the receiving wireless communication device includes means for receiving channel state information feedback from the transmitting wireless communication device.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

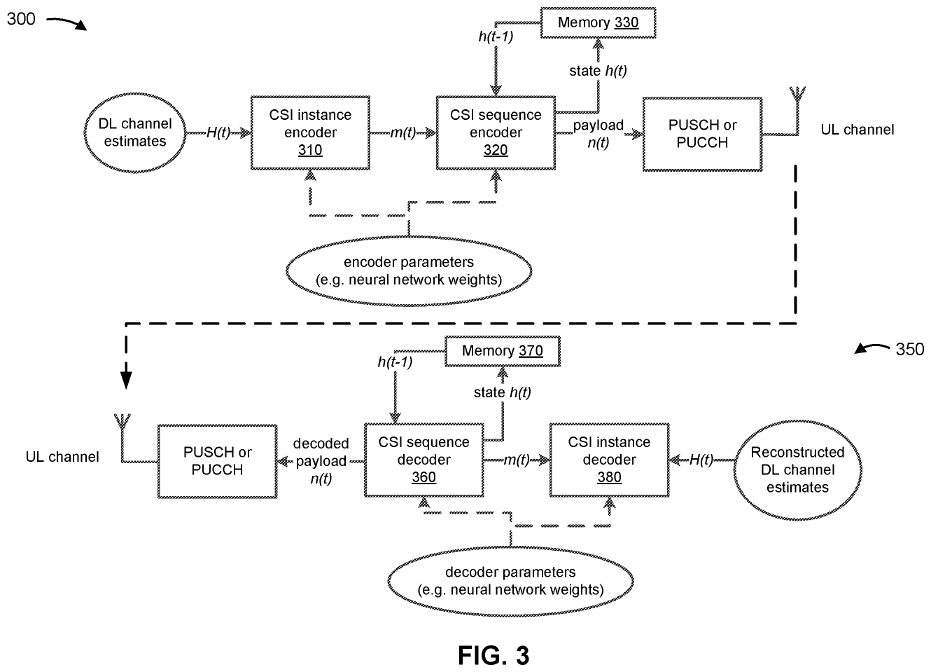

FIG. 3 illustrates an example of an encoding device 300 and a decoding device 350 that use previously stored channel state information (CSI), in accordance with the present disclosure. FIG. 3 shows the encoding device 300 (e.g., UE 120) with a CSI instance encoder 310, a CSI sequence encoder 320, and a memory 330. An encoding device may be configured to perform one or more operations on samples (e.g., data) received via one or more antennas of the encoding device to compress the samples. FIG. 3 also shows the decoding device 350 (e.g., BS 110) with a CSI sequence decoder 360, a memory 370, and a CSI instance decoder 380. A decoding device may be configured to decode the compressed samples to determine information, such as CSF.

In some aspects, the encoding device 300 and the decoding device 350 may take advantage of a correlation of CSI instances over time (temporal aspect), or over a sequence of CSI instances for a sequence of channel estimates. The encoding device 300 and the decoding device 350 may save and use previously stored CSI and encode and decode only a change in the CSI from a previous instance. This may provide for less CSI feedback overhead and improve performance. The encoding device 300 may also be able to encode more accurate CSI, and neural networks may be trained with more accurate CSI.

As shown in FIG. 3, CSI instance encoder 310 may encode a CSI instance into intermediate encoded CSI for each DL channel estimate in a sequence of DL channel estimates. CSI instance encoder 310 (e.g., a feedforward network) may use neural network encoder weights θ. The intermediate encoded CSI may be represented as m(t) [symbol] f_{enc,θ}(H(t)). CSI sequence encoder 320 (e.g., a Long Short-Term Memory (LSTM) network) may determine a previously encoded CSI instance h(t−1) from memory 330 and compare the intermediate encoded CSI m(t) and the previously encoded CSI instance h(t−1) to determine a change n(t) in the encoded CSI. The change n(t) may be a part of a channel estimate that is new and may not be predicted by the decoding device 350. The encoded CSI at this point may be represented by [n(t), h_{enc}(t)] [symbol] g_{enc,θ}(m(t), h_{enc}(t−1)). CSI sequence encoder 320 may provide this change n(t) on the physical uplink shared channel (PUSCH) or the physical uplink control channel (PUCCH), and the encoding device 300 may transmit the change (e.g., information indicating the change) n(t) as the encoded CSI on the UL channel to the decoding device 350. Because the change is smaller than an entire CSI instance, the encoding device 300 may send a smaller payload for the encoded CSI on the UL channel, while including more detailed information in the encoded CSI for the change. CSI sequence encoder 320 may generate encoded CSI h(t) based at least in part on the intermediate encoded CSI m(t) and at least a portion of the previously encoded CSI instance h(t−1). CSI sequence encoder 320 may save the encoded CSI h(t) in memory 330.

CSI sequence decoder 360 may receive encoded CSI on the PUSCH or PUCCH. CSI sequence decoder 360 may determine that only the change n(t) of CSI is received as the encoded CSI. CSI sequence decoder 360 may determine an intermediate decoded CSI m(t) based at least in part on the encoded CSI and at least a portion of a previous intermediate decoded CSI instance h(t−1) from memory 370 and the change. CSI instance decoder 380 may decode the intermediate decoded CSI m(t) into decoded CSI. CSI sequence decoder 360 and CSI instance decoder 380 may use neural network decoder weights ϕ. The intermediate decoded CSI may be represented by [\hat{m}(t), h_{dec}(t)] [symbol] g_{dec,ϕ}(n(t), h_{dec}(t−1)). CSI sequence decoder 360 may generate decoded CSI h(t) based at least in part on the intermediate decoded CSI m(t) and at least a portion of the previously decoded CSI instance h(t−1). The decoding device 350 may reconstruct a DL channel estimate from the decoded CSI h(t), and the reconstructed channel estimate may be represented as H\hat{ }(t)≙f_(dec, ϕ)(m\hat{ }(t)). CSI sequence decoder 360 may save the decoded CSI h(t) in memory 370.

Because the change n(t) is smaller than an entire CSI instance, the encoding device 300 may send a smaller payload on the UL channel. For example, if the DL channel has changed little from previous feedback, due to a low Doppler or little movement by the encoding device 300, an output of the CSI sequence encoder may be rather compact. In this way, the encoding device 300 may take advantage of a correlation of channel estimates over time. In some aspects, because the output is small, the encoding device 300 may include more detailed information in the encoded CSI for the change. In some aspects, the encoding device 300 may transmit an indication (e.g., flag) to the decoding device 350 that the encoded CSI is temporally encoded (a CSI change). Alternatively, the encoding device 300 may transmit an indication that the encoded CSI is encoded independently of any previously encoded CSI feedback. The decoding device 350 may decode the encoded CSI without using a previously decoded CSI instance. In some aspects, a device, which may include the encoding device 300 or the decoding device 350, may train a neural network model using a CSI sequence encoder and a CSI sequence decoder.

In some aspects, CSI may be a function of a channel estimate (referred to as a channel response) H and interference N. There may be multiple ways to convey H and N. For example, the encoding device 300 may encode the CSI as N^{-1/2}H. The encoding device 300 may encode H and N separately. The encoding device 300 may partially encode H and N separately, and then jointly encode the two partially encoded outputs. Encoding H and N separately maybe advantageous. Interference and channel variations may happen on different time scales. In a low Doppler scenario, a channel may be steady but interference may still change faster due to traffic or scheduler algorithms. In a high Doppler scenario, the channel may change faster than a scheduler-grouping of UEs. In some aspects, a device, which may include the encoding device 300 or the decoding device 350, may train a neural network model using separately encoded H and N.

In some aspects, a reconstructed DL channel Ĥ may faithfully reflect the DL channel H, and this may be called explicit feedback. In some aspects, Ĥ may capture only that information required for the decoding device 350 to derive rank and precoding. CQI may be fed back separately. CSI feedback may be expressed as m(t), or as n(t) in a scenario of temporal encoding. Similarly to Type-II CSI feedback, m(t) may be structured to be a concatenation of rank index (RI), beam indices, and coefficients representing amplitudes or phases. In some aspects, m(t) may be a quantized version of a real-valued vector. Beams may be pre-defined (not obtained by training), or may be a part of the training (e.g., part of θ and ϕ and conveyed to the encoding device 300 or the decoding device 350).

In some aspects, the decoding device 350 and the encoding device 300 may maintain multiple encoder and decoder networks, each targeting a different payload size (for varying accuracy vs. UL overhead tradeoff). For each CSI feedback, depending on a reconstruction quality and an uplink budget (e.g., PUSCH payload size), the encoding device 300 may choose, or the decoding device 350 may instruct the encoding device 300 to choose, one of the encoders to construct the encoded CSI. The encoding device 300 may send an index of the encoder along with the CSI based at least in part on an encoder chosen by the encoding device 300. Similarly, the decoding device 350 and the encoding device 300 may maintain multiple encoder and decoder networks to cope with different antenna geometries and channel conditions. Note that while some operations are described for the decoding device 350 and the encoding device 300, these operations may also be performed by another device, as part of a preconfiguration of encoder and decoder weights and/or structures.

As indicated above, FIG. 3 may be provided as an example. Other examples may differ from what is described with regard to FIG. 3.

As described herein, an encoding device operating in a network may measure reference signals and/or the like to report to a decoding device. For example, a UE may measure reference signals during a beam management process to report channel state information feedback (CSF), may measure received power of reference signals from a serving cell and/or neighbor cells, may measure signal strength of inter-radio access technology (e.g., WiFi) networks, may measure sensor signals for detecting locations of one or more objects within an environment, and/or the like. However, reporting this information to the network entity may consume communication and/or network resources.

In some aspects described herein, an encoding device (e.g., a UE) may train one or more neural networks to learn dependence of measured qualities on individual parameters, isolate the measured qualities through various layers of the one or more neural networks (also referred to as “operations”), and compress measurements in a way that limits compression loss.

In some aspects, the encoding device may use a nature of a quantity of bits being compressed to construct a process of extraction and compression of each feature (also referred to as a dimension) that affects the quantity of bits. In some aspects, the quantity of bits may be associated with sampling of one or more reference signals and/or may indicate channel state information.

Based at least in part on encoding and decoding a data set using a neural network for uplink communication, the encoding device may transmit CSF with a reduced payload. This may conserve network resources that may otherwise have been used to transmit a full data set as sampled by the encoding device.

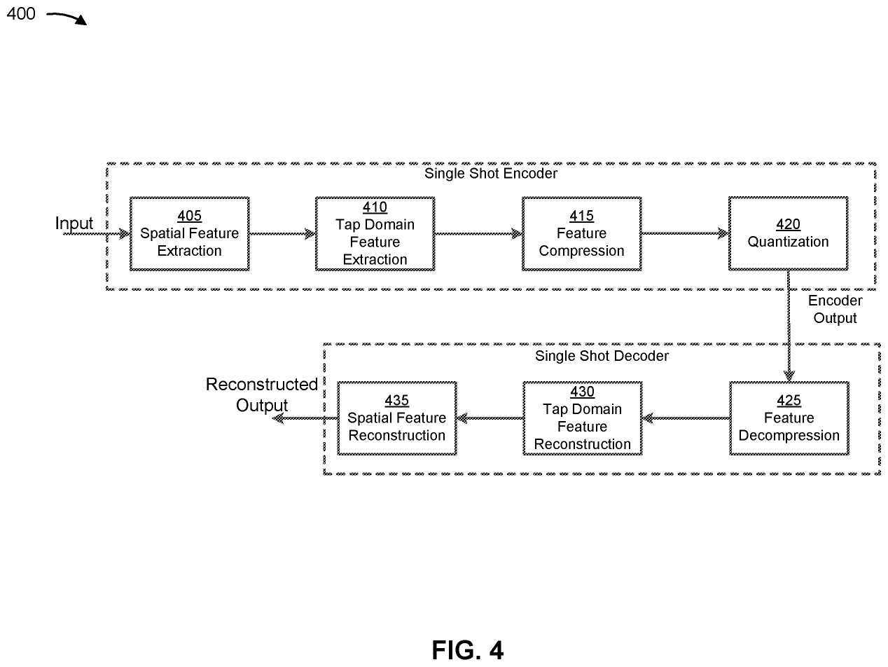

FIG. 4 is a diagram illustrating an example 400 associated with encoding and decoding a data set using a neural network for uplink communication, in accordance with the present disclosure. An encoding device (e.g., UE 120, encoding device 300, and/or the like) may be configured to perform one or more operations on samples (e.g., data) received via one or more antennas of the encoding device to compress the samples. As shown in FIG. 4, the encoding device may use a single shot encoder to perform a single shot encoding operation. A decoding device (e.g., base station 110, decoding device 350, and/or the like) may be configured to decode the compressed samples to determine information, such as CSF. As shown in FIG. 4, the decoding device may use a single shot decoder to perform a single shot decoding operation. An encoding device may be referred to, herein, as a transmitting wireless communication device. A decoding device may be referred to, herein, as a receiving wireless communication device.

In some aspects, the encoding device may identify a feature to compress. In some aspects, the encoding device may perform a first type of operation in a first dimension associated with the feature to compress. The encoding device may perform a second type of operation in other dimensions (e.g., in all other dimensions). For example, the encoding device may perform a fully connected operation on the first dimension and convolution (e.g., pointwise convolution) in all other dimensions.

In some aspects, the reference numbers identify operations that include multiple neural network layers and/or operations. Neural networks of the encoding device and the decoding device may be formed by concatenation of one or more of the referenced operations.

As shown by reference number 405, the encoding device may perform a spatial feature extraction on the data. As shown by reference number 410, the encoding device may perform a tap domain feature extraction on the data. In some aspects, the encoding device may perform the tap domain feature extraction before performing the spatial feature extraction. In some aspects, an extraction operation may include multiple operations. For example, the multiple operations may include one or more convolution operations, one or more fully connected operations, and/or the like, that may be activated or inactive. In some aspects, an extraction operation may include a residual neural network (ResNet) operation.

As shown by reference number 415, the encoding device may compress one or more features that have been extracted. In some aspects, a compression operation may include one or more operations, such as one or more convolution operations, one or more fully connected operations, and/or the like. After compression, a bit count of an output may be less than a bit count of an input.

As shown by reference number 420, the encoding device may perform a quantization operation. In some aspects, the encoding device may perform the quantization operation after flattening the output of the compression operation and/or performing a fully connected operation after flattening the output.

As shown by reference number 425, the decoding device may perform a feature decompression. As shown by reference number 430, the decoding device may perform a tap domain feature reconstruction. As shown by reference number 435, the decoding device may perform a spatial feature reconstruction. In some aspects, the decoding device may perform spatial feature reconstruction before performing tap domain feature reconstruction. After the reconstruction operations, the decoding device may output the reconstructed version of the encoding device's input.

In some aspects, the decoding device may perform operations in an order that is opposite to operations performed by the encoding device. For example, if the encoding device follows operations (A, B, C, D), the decoding device may follow inverse operations (D, C, B, A). In some aspects, the decoding device may perform operations that are fully symmetric to operations of the encoding device. This may reduce a number of bits needed for neural network configuration at the UE. In some aspects, the decoding device may perform additional operations (e.g., convolution operations, fully connected operations, ResNet operations, and/or the like) in addition to operations of the encoding device. In some aspects, the decoding device may perform operations that are asymmetric to operations of the encoding device.

Based at least in part on the encoding device encoding a data set using a neural network for uplink communication, the encoding device (e.g., a UE) may transmit CSF with a reduced payload. This may conserve network resources that may otherwise have been used to transmit a full data set as sampled by the encoding device.

As indicated above, FIG. 4 is provided as an example. Other examples may differ from what is described with regard to FIG. 4.

As described herein, a transmitting wireless communication device operating in a network may measure reference signals and/or the like to report to a receiving wireless communication device. For example, a transmitting wireless communication device may receive a neural network based channel state information (CSI) reference signal (CSI-RS). The receiving wireless communication device may measure neural network based CSI based at least in part on the CSI-RS. In some aspects, neural network based CSI may compress the channel information associated with the CSI-RS into a more comprehensive form than, for example, non-neural network based Type-II CSI or Type-I CSI. For example, in Type-II CSI, the sub-band size may be fixed for all sub-bands, which may result in limited granularity. Neural network based CSI may facilitate greater granularity by facilitating providing information regarding an entire channel. Neural network based CSI also may be specified to compress certain sub-bands with greater accuracy or less accuracy.

In some aspects, neural network based CSI also may facilitate multiple user (MU) multiple input multiple output (MU-MIMO) operation at a receiving wireless communication device, by facilitating providing information about a channel and interference, thereby enabling the receiving wireless communication device to manage and group users, and/or the like. Machine-learning based reporting of CSF may facilitate the use of Type III CSI. However, encoding using neural networks may still result in large payloads for reporting due to the presence of temporal data, which may have a negative impact on network performance.

According to aspects of the techniques and apparatuses described herein, a transmitting wireless communication device may be configured with one or more neural networks that facilitate temporal processing. In some aspects, a transmitting wireless communication device may encode a data set using a single shot encoding operation and a temporal processing operation associated with at least one neural network to produce an encoded data set. In some aspects, a dimensionality of a subset of inputs of a set of inputs to the temporal processing operation may be greater than a dimensionality of the encoded data set. Therefore, outputs from temporal processing may be used in future iterations of a temporal processing algorithm, enabling further and more accurate compression of data. As a result, some aspects may facilitate compression of temporal data, which may reduce payload size for reporting feedback, which may have a positive impact on network performance.

FIG. 5 is a diagram illustrating an example 500 associated with temporal processing associated with wireless transmission of encoded data, in accordance with the present disclosure. As shown, a transmitting wireless communication device (shown as a “first device”) 505 and a receiving wireless communication device (shown as a “second device”) 510 may communicate with one another. In some aspects, the first device 505 and the second device 510 may communicate via a wireless communication network (e.g., wireless network 100 shown in FIG. 1). The first device 505 may be an encoding device (e.g., UE 120, encoding device 300, and/or the like) and the second device 510 may be a decoding device (e.g., base station 110, decoding device 350, and/or the like).

As shown by reference number 515, the second device 510 may transmit, and the first device 505 may receive, an indication to determine the CSF (e.g., based at least in part on a neural network based CSI-RS). In some aspects, the indication to determine the CSF may be carried in DCI, a MAC-CE, and/or the like. In some aspects, the second device 510 may transmit an indication to estimate a channel and/or perform some other signal analysis using one or more neural networks. In some aspects, the first device 505 may perform an analysis without receiving an indication to do so.

As shown by reference number 520, the second device 510 may transmit, and the first device 505 may receive, a CSI-RS. In some aspects, the second device 510 may transmit a demodulation reference signal (DMRS) and/or a sounding reference signal (SRS), among other examples. As shown by reference number 525, the first device 505 may determine CSI and/or CSF based on the CSI and based at least in part on temporal processing, as described herein. In some aspects, the first device 505 may additionally or alternatively estimate a channel.

For example, in some aspects, the first device 505 may encode a data set using a single shot encoding operation and a temporal processing operation associated with at least one neural network to produce an encoded data set. A dimensionality of a subset of inputs of a set of inputs to the temporal processing operation may be greater than a dimensionality of the encoded data set. The data set may be based at least in part on sampling of one or more reference signals (e.g., a CSI-RS, a DMRS, and/or an SRS).

In some aspects, the subset of inputs of the set of inputs to the temporal processing operation may include a state vector that represents an output of a prior temporal processing operation. In some aspects, the set of inputs to the temporal processing operation may include an output of the single shot encoding operation, and a dimensionality of the state vector may be greater than a dimensionality of the output of the single shot encoding operation.

In some aspects, the first device 505 may encode the data set using a temporal processing block to perform the temporal processing operation. In some aspects, the temporal processing block may include a recurrent neural network (RNN) bank that includes one or more RNNs. The one or more RNNs may include at least one of: a long-short term memory, or a gated recurrent unit, or a basic RNN. In some aspects, the temporal processing block may include an output generator that includes at least one of: a fully connected layer, a convolutional layer, or a fully connected convolutional layer. The output generator may take, as input, an output of the RNN bank and may produce the encoded data set. Temporal compression blocks may contain various RNNs such as long short-term memory (LSTM) RNNs, gated recurrent units (GRUs), and/or fully connected convolutional layers, among other examples.

As shown by reference number 530, the first device 505 may transmit, and the second device 510 may receive, the neural network based CSF and/or channel estimation, among other examples.

As indicated above, FIG. 5 is provided as an example. Other examples may differ from what is described with regard to FIG. 5.

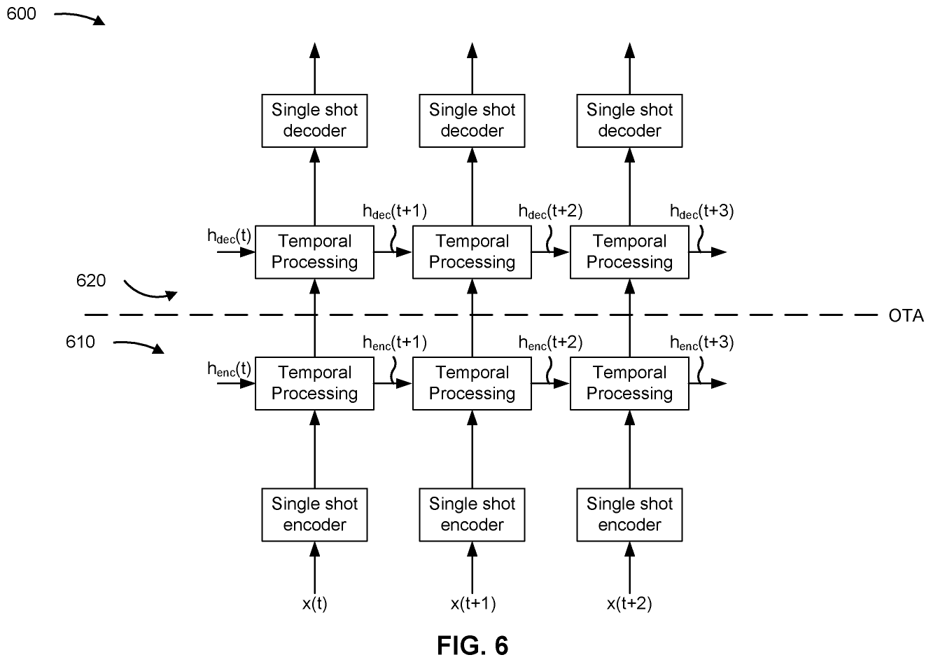

FIG. 6 is a diagram illustrating an example 600 associated with temporal processing associated with wireless transmission of encoded data, in accordance with the present disclosure. Example 600 illustrates an architecture associated with temporal processing associated with wireless transmission of encoded data. Example 600 depicts a number of states of the architecture, each in accordance with a time (t+1, t+2, and t+3).

As shown in FIG. 6, a transmitting wireless communication device 610 may include a single shot encoder that provides an input to a temporal processing block. As shown in FIG. 4, the single shot encoder is an encoder that performs a single shot (also known as “one-shot”) encoding operation. A single shot encoding operation is an operation that encodes a single instance of data (e.g., a set of data from a measurement at an instant in time). The output of the temporal processing block may be transmitted over the air (OTA) to a receiving wireless communication device 620. The receiving wireless communication device 620 includes a temporal processing block that receives the encoded data set and provides an input to a single shot decoder. As shown in FIG. 4, the single shot decoder is a decoder that performs a single shot (also known as “one-shot”) decoding operation. A single shot decoding operation is an operation that decodes a single instance of data (e.g., a set of data from a measurement at an instant in time). The subset of inputs of the set of inputs to the temporal processing block may include a state vector, h_{enc}(T) (on the encoder side) or h_{dec}(T) (on the decoder side) that represents an output of a prior temporal processing operation, where T is a time variable representing time slots T=t, t+1, t+2, t+3, . . . . The single shot encoder takes, as input, the data set, x(T), and outputs the one-shot encoded data set to the temporal processing block. The temporal processing block may perform a temporal compression to provide an output encoded data set, which is transmitted to the receiving wireless communication device. The temporal processing block also may evolve the state vector and provide the evolved state vector to the next temporal processing operation. In some aspects, the dimension of the state vector may be much larger than that of the output transmitted OTA to the receiving wireless communication device 620.

As indicated above, FIG. 6 is provided as an example. Other examples may differ from what is described with regard to FIG. 6.

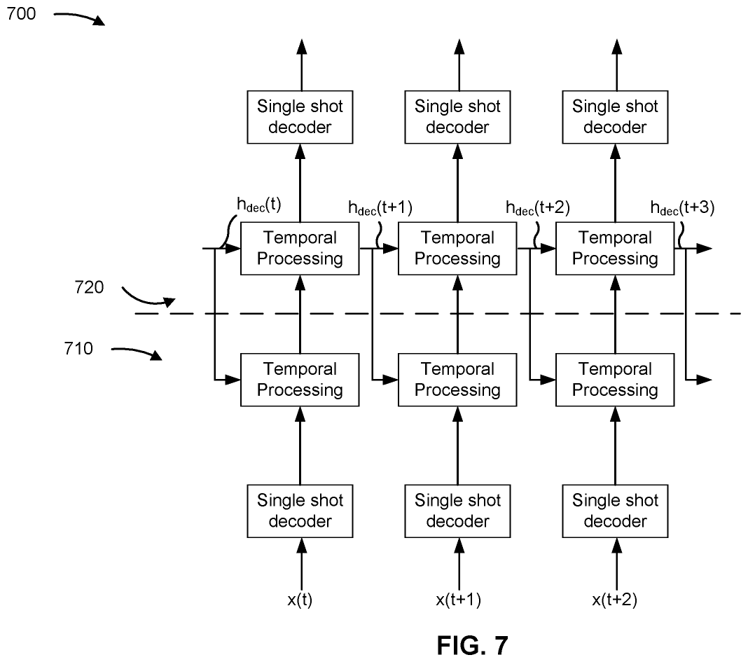

FIG. 7 is a diagram illustrating an example 700 associated with temporal processing associated with wireless transmission of encoded data, in accordance with the present disclosure. Example 700 illustrates an architecture associated with temporal processing associated with wireless transmission of encoded data. Example 700 depicts a number of states of the architecture, each in accordance with a time (t+1, t+2, and t+3). The architecture in FIG. 7 is similar to that of FIG. 6, except that the subset of inputs of the set of inputs to the temporal processing operation of the transmitting wireless communication device 710 and the receiving wireless communication device 720 includes a state vector that represents an output of a prior temporal processing operation, where the prior temporal processing operation is associated with a decoder of the receiving wireless communication device 720.

As indicated above, FIG. 7 is provided as an example. Other examples may differ from what is described with regard to FIG. 7.

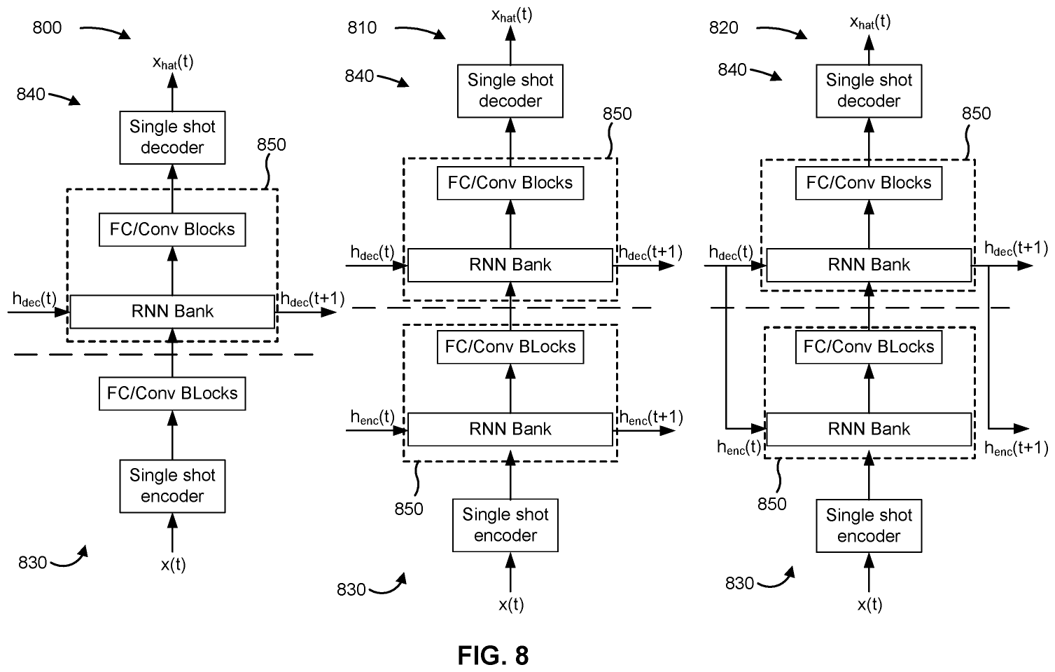

FIG. 8 is a diagram illustrating examples 800, 810, and 820 associated with temporal processing associated with wireless transmission of encoded data, in accordance with the present disclosure. Example 800 illustrates an architecture in which the transmitting wireless communication device 830 does not include a temporal processing block, but the receiving wireless communication device 840 does include a temporal processing block 850.

Example 810 illustrates an architecture similar to the architecture of example 600 shown in FIG. 6, in which the transmitting wireless communication device 830 includes a temporal processing block 850 and the receiving wireless communication device 840 also includes a temporal processing block 850. As shown, the temporal processing block 850 may include an RNN bank and an output generator (shown as “FC/Conv Blocks”) that includes at least one of: a fully connected layer, a convolutional layer, or a fully connected convolutional layer. The output generator may take, as input, an output of the RNN bank and may produce the encoded data set.

Example 820 illustrates an architecture similar to the architecture of example 700 shown in FIG. 7, in which the transmitting wireless communication device 830 includes a temporal processing block 850 and the receiving wireless communication device 840 also includes a temporal processing block 850. As shown, the temporal processing block 850 may include an RNN bank and an output generator (shown as “FC/Conv Blocks”) that includes at least one of: a fully connected layer, a convolutional layer, or a fully connected convolutional layer.

As indicated above, FIG. 8 is provided as an example. Other examples may differ from what is described with regard to FIG. 8.

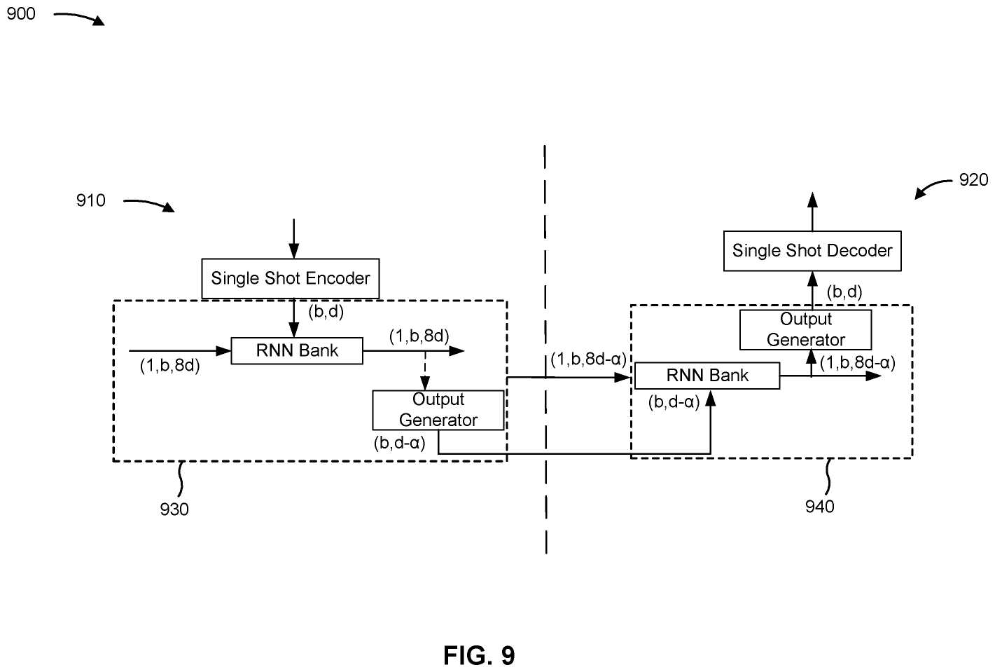

FIG. 9 is a diagram illustrating an example 900 associated with temporal processing associated with wireless transmission of encoded data, in accordance with the present disclosure. Example 900 illustrates an architecture associated with temporal processing associated with wireless transmission of encoded data. As shown, a transmitting wireless communication device 910 may communicate with a receiving wireless communication device 920.

As shown, a transmitting wireless communication device 910 includes a single shot encoder that provides an input to an RNN bank of a temporal processing block 930. The input includes a batch size b and a number of dimensions d. The RNN bank also receives a set of inputs, represented as (1,b,8d), from a prior temporal processing operation. The first variable, 1, is an iteration index, and the set of inputs includes 8d dimensions, as indicated by 8d. The RNN bank produces an output having 8 dimensions as input to the output generator. Although, in the example, the RNN bank produces output having 8 dimensions, 8 is meant as an example. The output dimensions could be larger or smaller than 8. The output generator compresses the input, producing an output having d-α dimensions, where a represents the number of dimensions compressed. The opposite process is shown as occurring on the receiving wireless communication device 920 to decode the encoded data using a temporal processing block 940. In this way, the original data, having dimension d, may be recovered by the receiving wireless communication device 920.

In some aspects, the RNN bank may be configured to select one or more dimensions of a set of dimensions for an input to have based at least in part on a correlation between the one or more dimensions and at least one additional dimension of the set of dimensions. In some aspects, if the RNN identifies low correlation dimensions as inputs, the RNN may default to a performance where the RNN chooses one dimension at a time slot. As the correlation across dimensions increases, the RNN bank may choose a more complex function of the inputs to compress the inputs to a lower dimension.

As indicated above, FIG. 9 is provided as an example. Other examples may differ from what is described with regard to FIG. 9.

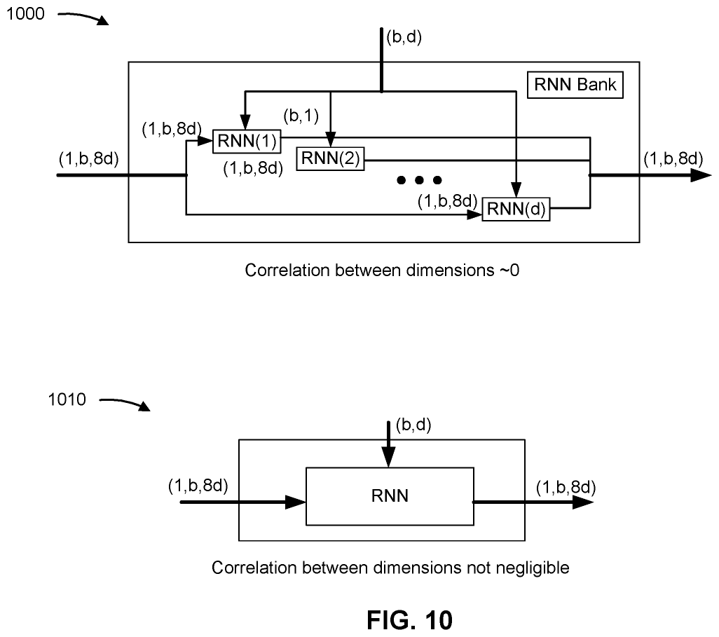

FIG. 10 is a diagram illustrating examples 1000 and 1010 associated with temporal processing associated with wireless transmission of encoded data, in accordance with the present disclosure. Examples 1000 and 1010 illustrate an architecture associated with temporal processing associated with wireless transmission of encoded data.

As explained above, in connection with FIG. 9, an RNN bank may be configured to select one or more dimensions of a set of dimensions for an input to have based at least in part on a correlation between the one or more dimensions and at least one additional dimension of the set of dimensions. Example 1000 illustrates an RNN bank in which correlation between dimensions is low (e.g., approximately zero). In this case, the RNN bank may include a plurality of RNNs (shown as “RNN(1),” “RNN(2),” . . . , “RNN(d)”), where each RNN of the plurality of RNNs corresponds to a different dimension of a plurality of d dimensions.

In contrast, when correlation between dimensions is not negligible, an RNN bank may include fewer RNNs. For example, as shown by Example 1010, the RNN bank may include a single RNN that processes all of the dimensions of the plurality of dimensions. In such a case, the number of RNNs may be lower, but the complexity of the RNNs may be higher.

As indicated above, FIG. 10 is provided merely as an example. Other examples may differ from what is described with regard to FIG. 10.

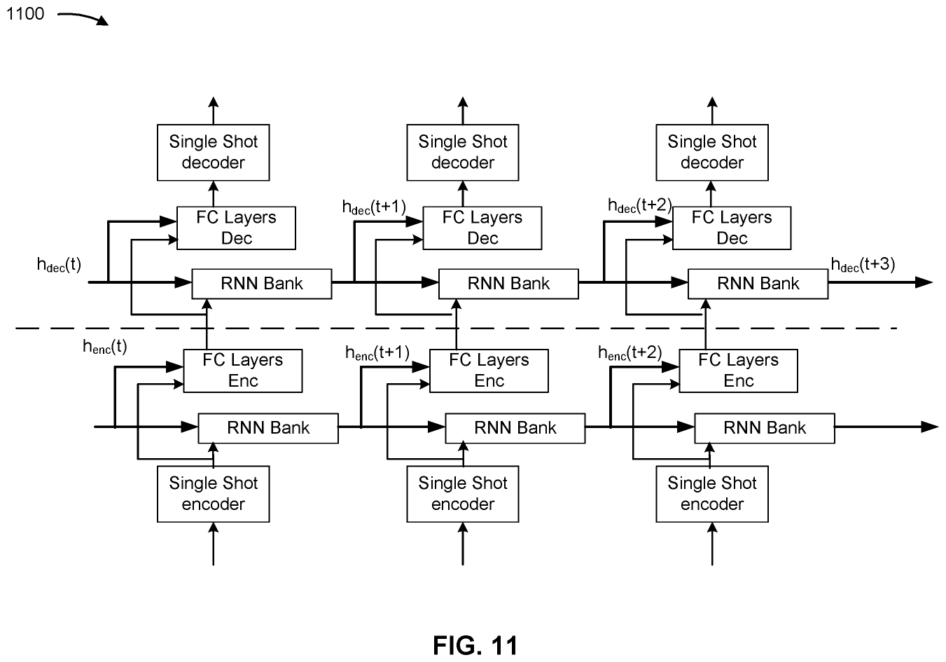

FIG. 11 is a diagram illustrating an example 1100 associated with temporal processing associated with wireless transmission of encoded data, in accordance with the present disclosure. Example 1100 illustrates another architecture associated with temporal processing associated with wireless transmission of encoded data.

Example 1100 illustrates a more complex architecture in which a temporal processing block of a transmitting wireless communication device 1110 includes an RNN bank and an output generator (shown as “FC Layers Enc”) and in which the receiving wireless communication device 1120 includes a mirrored structure, having an RNN bank and an output generator (shown as “FC Layers Dec”).

As shown, the output generator takes, as input, an output of the RNN bank and produces the encoded data set. The output of the RNN bank may include a state vector associated with a first time, and the output generator takes, as additional input, an output of a single-shot encoder associated with a second time, wherein the second time occurs after the first time. In this example 1100, the RNN bank (which may include one or more RNNs, GRUs, and/or LSTMs) is used to evolve the state. Inputs to the RNN bank along with the previous state are used to generate the outputs. In some aspects, the state vectors may be of a much higher dimension than the actual outputs of the single shot encoder, or the final outputs of the encoder. The output generator uses the high dimension previous state and the low dimension current inputs to generate overall outputs. In this way, the architecture of FIG. 11 may include additional feedback loops for evolving the state of the temporal processing block to further enhance the accuracy and efficiency of the system.

As indicated above, FIG. 11 is provided as an example. Other examples may differ from what is described with regard to FIG. 11.

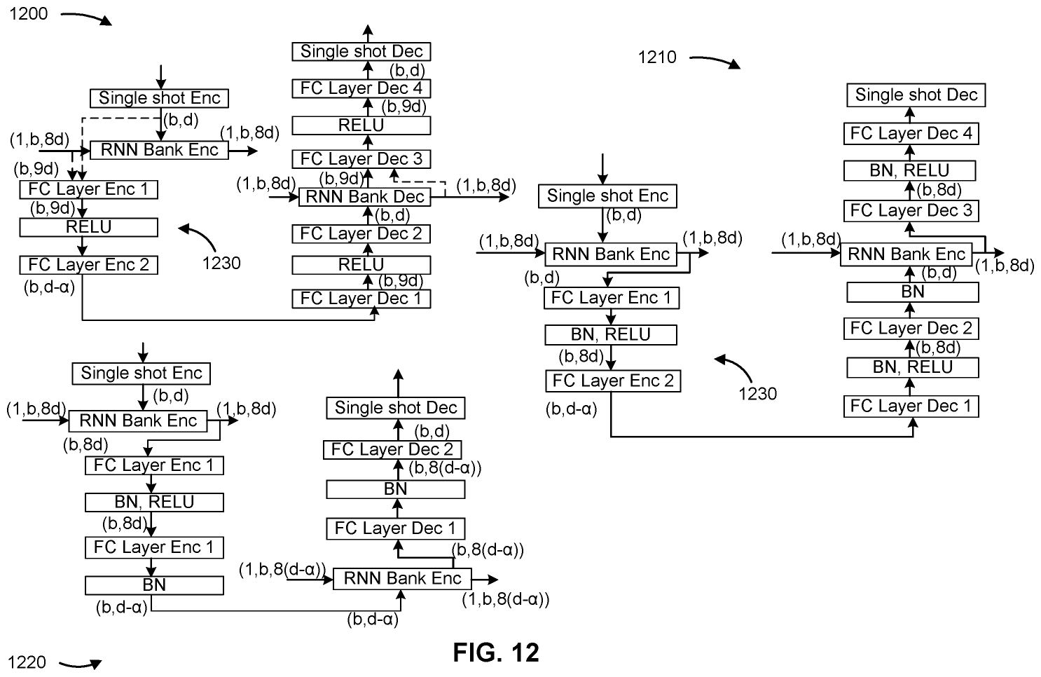

FIG. 12 is a diagram illustrating examples 1200, 1210, and 1220 associated with temporal processing associated with wireless transmission of encoded data, in accordance with the present disclosure.

As shown by reference number 1200, an example architecture may include an output generator 1230 that includes a first fully connected layer (FC Layer Enc 1) that produces a first output having a first number of dimensions (e.g., 9d). The illustrated dimension factor of 9 is meant as an example. The dimension factor may be larger than 9 or smaller than 9. The output generator 1230 may include a rectified linear unit (ReLU) activation layer that receives the first output and produces a second output having the first number of dimensions, and a second fully connected layer (FC Layer Enc 2) that receives the second output and produces a third output having a second number of dimensions (d-a) that is less than the first number of dimensions.

As shown by reference number 1210, an example architecture may include an output generator 1240 that includes a structure similar to that depicted in the example architecture of example 1200, except that the ReLU layer also includes a first batch normalization (BN) layer. As shown by reference number 1220, a similar architecture may include a second BN layer that receives the third output and produces a fourth output having the second number of dimensions. As shown in FIG. 12, decoder architectures may include similar structures discussed above with regard to encoder structures.

For example, the decoders may include an RNN bank that produces a first output having a first number of dimensions and an output generator that includes a first fully connected layer that receives the first output and produces a second output having the first number of dimensions; a first middle layer that receives the second output and produces a third output having the first number of dimensions, where the first middle layer comprises at least one of a BN layer or a ReLU layer; and a second fully connected layer that receives the third output and produces a fourth output having a second number of dimensions that is greater than the first number of dimensions.

The temporal processing operations of examples 1200 and 1210 may include a third fully connected layer that receives the encoded data set and produces a fifth output having the first number of dimensions; a second middle layer that receives the fifth output and produces a sixth output having the first number of dimensions, wherein the second middle layer comprises at least one of a BN layer or a ReLU layer; and a fourth fully connected layer that receives the sixth output and produces a seventh output having the first number of dimensions. The temporal processing operations of example 1220 may include a BN layer that receives the seventh output and produces an eighth output having the second number of dimensions, wherein the eighth output comprises an input to the RNN bank.

As indicated above, FIG. 12 is provided as an example. Other examples may differ from what is described with regard to FIG. 12.

FIG. 13 is a diagram illustrating an example process 1300 performed, for example, by a transmitting wireless communication device, in accordance with the present disclosure. Example process 1300 is an example where the transmitting wireless communication device (e.g., first device 505) performs operations associated with architectures for temporal processing associated with wireless transmission of encoded data.

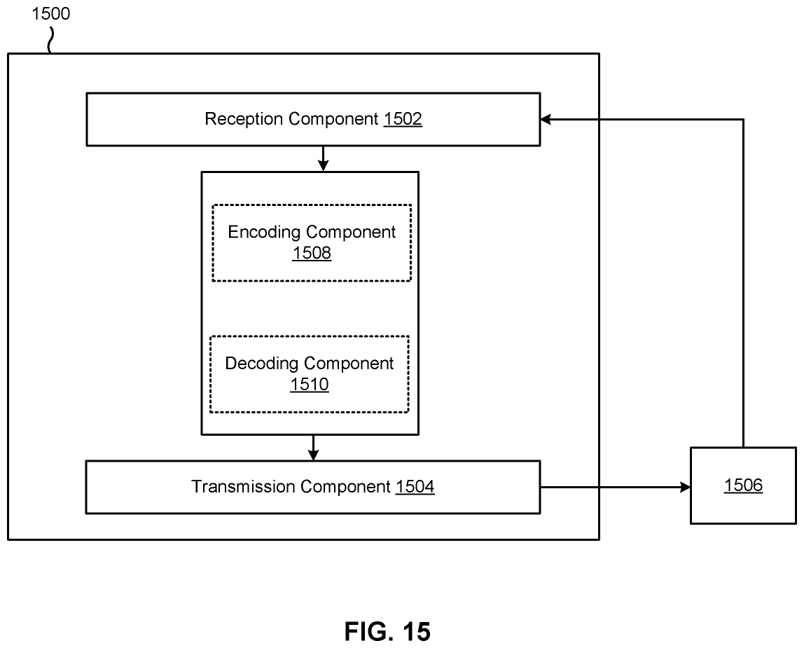

As shown in FIG. 13, in some aspects, process 1300 may include encoding a data set using a single shot encoding operation and a temporal processing operation associated with at least one neural network to produce an encoded data set, wherein a dimensionality of a subset of inputs of a set of inputs to the temporal processing operation is greater than a dimensionality of the encoded data set (block 1310). For example, the transmitting wireless communication device (e.g., using encoding component 1508, depicted in FIG. 15) may encode a data set using a single shot encoding operation and a temporal processing operation associated with at least one neural network to produce an encoded data set, wherein a dimensionality of a subset of inputs of a set of inputs to the temporal processing operation is greater than a dimensionality of the encoded data set, as described above.

As further shown in FIG. 13, in some aspects, process 1300 may include transmitting the encoded data set to a receiving wireless communication device (block 1320). For example, the transmitting wireless communication device (e.g., using transmission component 1504, depicted in FIG. 15) may transmit the encoded data set to a receiving wireless communication device, as described above.

Process 1300 may include additional aspects, such as any single aspect or any combination of aspects described below and/or in connection with one or more other processes described elsewhere herein.

In a first aspect, the data set is based at least in part on sampling of one or more reference signals.

In a second aspect, alone or in combination with the first aspect, transmitting the encoded data set to the receiving wireless communication device comprises transmitting channel state information feedback to the receiving wireless communication device.

In a third aspect, alone or in combination with one or more of the first and second aspects, the subset of inputs of the set of inputs to the temporal processing operation comprises a state vector that represents an output of a prior temporal processing operation.

In a fourth aspect, alone or in combination with one or more of the first through third aspects, the set of inputs to the temporal processing operation further comprises an output of the single shot encoding operation, and a dimensionality of the state vector is greater than a dimensionality of the output of the single shot encoding operation.

In a fifth aspect, alone or in combination with one or more of the first through fourth aspects, the prior temporal processing operation is associated with an encoder of the transmitting wireless communication device.

In a sixth aspect, alone or in combination with one or more of the first through fifth aspects, the prior temporal processing operation is associated with a decoder of the receiving wireless communication device.

In a seventh aspect, alone or in combination with one or more of the first through sixth aspects, encoding the data set using the temporal processing operation comprises performing the temporal processing operation using a temporal processing block.

In an eighth aspect, alone or in combination with one or more of the first through seventh aspects, the temporal processing block comprises an RNN bank that includes one or more RNNs.

In a ninth aspect, alone or in combination with one or more of the first through eighth aspects, the one or more RNNs include at least one of an LSTM, a GRU, or a basic RNN.

In a tenth aspect, alone or in combination with one or more of the first through ninth aspects, the temporal processing block comprises an output generator that includes at least one of a fully connected layer, a convolutional layer, or a fully connected convolutional layer.

In an eleventh aspect, alone or in combination with one or more of the first through tenth aspects, the output generator takes, as input, an output of an RNN bank and produces the encoded data set.

In a twelfth aspect, alone or in combination with one or more of the first through eleventh aspects, the output of the RNN bank comprises a state vector associated with a first time, and the output generator takes, as additional input, an output of a single-shot encoder associated with a second time, wherein the second time occurs after the first time.

In a thirteenth aspect, alone or in combination with one or more of the first through twelfth aspects, the output generator comprises a first fully connected layer that produces a first output having a first number of dimensions, a ReLU activation layer that receives the first output and produces a second output having the first number of dimensions, and a second fully connected layer that receives the second output and produces a third output having a second number of dimensions that is less than the first number of dimensions.

In a fourteenth aspect, alone or in combination with one or more of the first through thirteenth aspects, an input of the RNN bank comprises a state vector associated with a first time, wherein the output of the RNN bank comprises a state vector associated with a second time, and the output generator takes, as additional input, an output of a single-shot encoder associated with the second time, wherein the second time occurs after the first time.

In a fifteenth aspect, alone or in combination with one or more of the first through fourteenth aspects, the output generator comprises a first fully connected layer that produces a first output having a first number of dimensions, a first BN and ReLU activation layer that receives the first output and produces a second output having the first number of dimensions, and a second fully connected layer that receives the second output and produces a third output having a second number of dimensions that is less than the first number of dimensions.

In a sixteenth aspect, alone or in combination with one or more of the first through fifteenth aspects, the output generator further comprises a second BN layer that receives the third output and produces a fourth output having the second number of dimensions.

In a seventeenth aspect, alone or in combination with one or more of the first through sixteenth aspects, the RNN bank is configured to select one or more dimensions of a set of dimensions for an input to have based at least in part on a correlation between the one or more dimensions and at least one additional dimension of the set of dimensions.

In an eighteenth aspect, alone or in combination with one or more of the first through seventeenth aspects, the RNN bank comprises a plurality of RNNs, each RNN of the plurality of RNNs corresponding to a different dimension of a plurality of dimensions.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a receiving wireless communication device, in accordance with the present disclosure. Example process 1400 is an example where the receiving wireless communication device (e.g., second device 510) performs operations associated with architectures for temporal processing associated with wireless transmission of encoded data.

As shown in FIG. 14, in some aspects, process 1400 may include receiving an encoded data set from a transmitting wireless communication device (block 1410). For example, the receiving wireless communication device (e.g., using reception component 1502, depicted in FIG. 15) may receive an encoded data set from a transmitting wireless communication device, as described above.

As further shown in FIG. 14, in some aspects, process 1400 may include decoding the encoded data set using a single shot decoding operation and a temporal processing operation associated with at least one neural network to produce a decoded data set, wherein a dimensionality of a subset of inputs of a set of inputs to the temporal processing operation is less than a dimensionality of the decoded data set (block 1420). For example, the receiving wireless communication device (e.g., using decoding component 1510, depicted in FIG. 15) may decode the encoded data set using a single shot decoding operation and a temporal processing operation associated with at least one neural network to produce a decoded data set, wherein a dimensionality of a subset of inputs of a set of inputs to the temporal processing operation is less than a dimensionality of the decoded data set, as described above.

Process 1400 may include additional aspects, such as any single aspect or any combination of aspects described below and/or in connection with one or more other processes described elsewhere herein.

In a first aspect, the encoded data set is based at least in part on a sampling of one or more reference signals.

In a second aspect, alone or in combination with the first aspect, receiving the encoded data set from the transmitting wireless communication device comprises receiving channel state information feedback from the transmitting wireless communication device.

In a third aspect, alone or in combination with one or more of the first and second aspects, the subset of inputs of the set of inputs to the temporal processing operation comprises a state vector that represents an output of a prior temporal processing operation.

In a fourth aspect, alone or in combination with the third aspect, an output of the temporal processing operation comprises an input to the single shot decoding operation, and wherein a dimensionality of the state vector is less than a dimensionality of the input to the single shot decoding operation.

In a fifth aspect, alone or in combination with one or more of the third through fourth aspects, the prior temporal processing operation is associated with a decoder of the receiving wireless communication device.

In a sixth aspect, alone or in combination with one or more of the first through fifth aspects, decoding the encoded data set using the temporal processing operation comprises performing the temporal processing operation using a temporal processing block.

In a seventh aspect, alone or in combination with the sixth aspect, the temporal processing block comprises a recurrent neural network (RNN) bank that includes one or more RNNs, wherein an input of the RNN bank comprises a state vector associated with a first time, and wherein an output of the RNN bank comprises a state vector associated with a second time.

In an eighth aspect, alone or in combination with the seventh aspect, the one or more RNNs include at least one of a long-short term memory, a gated recurrent unit, or a basic RNN.

In a ninth aspect, alone or in combination with one or more of the seventh through eighth aspects, the temporal processing block comprises an output generator that includes at least one of a fully connected layer, a convolutional layer, or a fully connected convolutional layer.

In a tenth aspect, alone or in combination with the ninth aspect, the output generator that takes, as input, an output of a recurrent neural network bank and produces the decoded data set.

In an eleventh aspect, alone or in combination with one or more of the seventh through tenth aspects, the RNN bank produces a first output having a first number of dimensions, and wherein the output generator comprises a first fully connected layer that receives the first output and produces a second output having the first number of dimensions, a first middle layer that receives the second output and produces a third output having the first number of dimensions, wherein the first middle layer comprises at least one of a batch normalization (BN) layer or a rectified linear unit (ReLU) layer, and a second fully connected layer that receives the third output and produces a fourth output having a second number of dimensions that is greater than the first number of dimensions.

In a twelfth aspect, alone or in combination with the eleventh aspect, the temporal processing block comprises a third fully connected layer that receives the encoded data set and produces a fifth output having the first number of dimensions, a second middle layer that receives the fifth output and produces a sixth output having the first number of dimensions, wherein the second middle layer comprises at least one of a BN layer or a ReLU layer, and a fourth fully connected layer that receives the sixth output and produces a seventh output having the first number of dimensions.

In a thirteenth aspect, alone or in combination with the twelfth aspect, the temporal processing block further comprises a BN layer that receives the seventh output and produces an eighth output having the second number of dimensions, wherein the eighth output comprises an input to the RNN bank.

In a fourteenth aspect, alone or in combination with one or more of the seventh through thirteenth aspects, the RNN bank is configured to select one or more dimensions of a set of dimensions to use as input based at least in part on a correlation between the one or more dimensions and at least one additional dimension of the set of dimensions.

In a fifteenth aspect, alone or in combination with one or more of the seventh through fourteenth aspects, the RNN bank comprises a plurality of RNNs, each RNN of the plurality of RNNs corresponding to a different dimension of a plurality of dimensions.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a block diagram of an example apparatus 1500 for wireless communication. The apparatus 1500 may be a wireless communication device, or a wireless communication device may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include one or more of an encoding component 1508, or a decoding component 1510, among other examples.

In some aspects, the apparatus 1500 may be configured to perform one or more operations described herein in connection with FIGS. 5-12. Additionally, or alternatively, the apparatus 1500 may be configured to perform one or more processes described herein, such as process 1300 of FIG. 13, process 1400 of FIG. 14, or a combination thereof. In some aspects, the apparatus 1500 and/or one or more components shown in FIG. 15 may include one or more components of the wireless communication device described above in connection with FIG. 2. Additionally, or alternatively, one or more components shown in FIG. 15 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1506. In some aspects, the reception component 1502 may include one or more antennas, a demodulator, a MIMO detector, a receive processor, a controller/processor, a memory, or a combination thereof, of the UE and/or base station described above in connection with FIG. 2.

The transmission component 1504 may transmit communications, such as reference signals, control information, data communications, or a combination thereof, to the apparatus 1506. In some aspects, one or more other components of the apparatus 1506 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modulator, a transmit MIMO processor, a transmit processor, a controller/processor, a memory, or a combination thereof, of the UE and/or base station described above in connection with FIG. 2. In some aspects, the transmission component 1504 may be co-located with the reception component 1502 in a transceiver.

The encoding component 1508 may encode a data set using a single shot encoding operation and a temporal processing operation associated with at least one neural network to produce an encoded data set, wherein a dimensionality of a subset of inputs of a set of inputs to the temporal processing operation is greater than a dimensionality of the encoded data set. In some aspects, the encoding component 1508 may include a modulator, a transmit MIMO processor, a transmit processor, a controller/processor, a memory, or a combination thereof, of the UE and/or base station described above in connection with FIG. 2. The transmission component 1504 may transmit the encoded data set to a receiving wireless communication device.

The reception component 1502 may receive an encoded data set from a transmitting wireless communication device. The decoding component 1510 may decode the encoded data set using a single shot decoding operation and a temporal processing operation associated with at least one neural network to produce a decoded data set, wherein a dimensionality of a subset of inputs of a set of inputs to the temporal processing operation is less than a dimensionality of the decoded data set. In some aspects, the decoding component 1510 may include a demodulator, a MIMO detector, a receive processor, a controller/processor, a memory, or a combination thereof, of the UE and/or base station described above in connection with FIG. 2.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a transmitting wireless communication device, comprising: encoding a data set using a single shot encoding operation and a temporal processing operation associated with at least one neural network to produce an encoded data set, wherein a dimensionality of a subset of inputs of a set of inputs to the temporal processing operation is greater than a dimensionality of the encoded data set; and transmitting the encoded data set to a receiving wireless communication device.

Aspect 2: The method of Aspect 1, wherein the data set is based at least in part on sampling of one or more reference signals.

Aspect 3: The method of either of Aspects 1 or 2, wherein transmitting the encoded data set to the receiving wireless communication device comprises: transmitting channel state information feedback to the receiving wireless communication device.

Aspect 4: The method of any of Aspects 1-3, wherein the subset of inputs of the set of inputs to the temporal processing operation comprises a state vector that represents an output of a prior temporal processing operation.

Aspect 5: The method of Aspect 4, wherein the set of inputs to the temporal processing operation further comprises an output of the single shot encoding operation, and wherein a dimensionality of the state vector is greater than a dimensionality of the output of the single shot encoding operation.

Aspect 6: The method of either of Aspects 4 or 5, wherein the prior temporal processing operation is associated with an encoder of the transmitting wireless communication device.

Aspect 7: The method of either of Aspects 4 or 5, wherein the prior temporal processing operation is associated with a decoder of the receiving wireless communication device.

Aspect 8: The method of any of Aspects 1-7, wherein encoding the data set using the temporal processing operation comprises performing the temporal processing operation using a temporal processing block.

Aspect 9: The method of Aspect 8, wherein the temporal processing block comprises a recurrent neural network (RNN) bank that includes one or more RNNs.

Aspect 10: The method of Aspect 9, wherein the one or more RNNs include at least one of: a long-short term memory, a gated recurrent unit, or a basic RNN.

Aspect 11: The method of any of Aspects 8-10, wherein the temporal processing block comprises an output generator that includes at least one of: a fully connected layer, a convolutional layer, or a fully connected convolutional layer.

Aspect 12: The method of Aspect 11, wherein the output generator takes, as input, an output of a recurrent neural network (RNN) bank and produces the encoded data set.

Aspect 13: The method of Aspect 12, wherein the output of the RNN bank comprises a state vector associated with a first time, and wherein the output generator takes, as additional input, an output of a single-shot encoder associated with a second time, wherein the second time occurs after the first time.

Aspect 14: The method of Aspect 13, wherein the output generator comprises: a first fully connected layer that produces a first output having a first number of dimensions; a rectified linear unit (ReLU) activation layer that receives the first output and produces a second output having the first number of dimensions; and a second fully connected layer that receives the second output and produces a third output having a second number of dimensions that is less than the first number of dimensions.

Aspect 15: The method of any of Aspects 12-14, wherein an input of the RNN bank comprises a state vector associated with a first time, wherein the output of the RNN bank comprises a state vector associated with a second time, and wherein the output generator takes, as additional input, an output of a single-shot encoder associated with the second time, wherein the second time occurs after the first time.

Aspect 16: The method of Aspect 15, wherein the output generator comprises: a first fully connected layer that produces a first output having a first number of dimensions; a first batch normalization (BN) and rectified linear unit (ReLU) activation layer that receives the first output and produces a second output having the first number of dimensions; and a second fully connected layer that receives the second output and produces a third output having a second number of dimensions that is less than the first number of dimensions.

Aspect 17: The method of Aspect 16, wherein the output generator further comprises a second BN layer that receives the third output and produces a fourth output having the second number of dimensions.

Aspect 18: The method of any of Aspects 9-17, wherein the RNN bank is configured to select one or more dimensions of a set of dimensions for an input to have based at least in part on a correlation between the one or more dimensions and at least one additional dimension of the set of dimensions.

Aspect 19: The method of any of Aspects 9-17, wherein the RNN bank comprises a plurality of RNNs, each RNN of the plurality of RNNs corresponding to a different dimension of a plurality of dimensions.

Aspect 20: A method of wireless communication performed by a receiving wireless communication device, comprising: receiving an encoded data set from a transmitting wireless communication device; and decoding the encoded data set using a single shot decoding operation and a temporal processing operation associated with at least one neural network to produce a decoded data set, wherein a dimensionality of a subset of inputs of a set of inputs to the temporal processing operation is fewer than a dimensionality of the decoded data set.

Aspect 21: The method of Aspect 20, wherein the encoded data set is based at least in part on a sampling of one or more reference signals.

Aspect 22: The method of either of Aspects 20 or 21, wherein receiving the encoded data set from the transmitting wireless communication device comprises: receiving channel state information feedback from the transmitting wireless communication device.

Aspect 23: The method of any of Aspects 20-22, wherein the subset of inputs of the set of inputs to the temporal processing operation comprises a state vector that represents an output of a prior temporal processing operation.

Aspect 24: The method of Aspect 23, wherein an output of the temporal processing operation comprises an input to the single shot decoding operation, and wherein a dimensionality of the state vector is less than a dimensionality of the input to the single shot decoding operation.

Aspect 25: The method of either of Aspects 23 or 24, wherein the prior temporal processing operation is associated with a decoder of the receiving wireless communication device.

Aspect 26: The method of any of Aspects 20-25, wherein decoding the encoded data set using the temporal processing operation comprises performing the temporal processing operation using a temporal processing block.

Aspect 27: The method of Aspect 26, wherein the temporal processing block comprises a recurrent neural network (RNN) bank that includes one or more RNNs, wherein an input of the RNN bank comprises a state vector associated with a first time, and wherein an output of the RNN bank comprises a state vector associated with a second time.

Aspect 28: The method of Aspect 27, wherein the one or more RNNs include at least one of: a long-short term memory, a gated recurrent unit, or a basic RNN.

Aspect 29: The method of either of Aspects 27 or 28, wherein the temporal processing block comprises an output generator that includes at least one of: a fully connected layer, a convolutional layer, or a fully connected convolutional layer.

Aspect 30: The method of Aspect 29, wherein the output generator that takes, as input, an output of a recurrent neural network bank and produces the decoded data set.

Aspect 31: The method of any of Aspects 27-30, wherein the RNN bank produces a first output having a first number of dimensions, and wherein the output generator comprises: a first fully connected layer that receives the first output and produces a second output having the first number of dimensions; a first middle layer that receives the second output and produces a third output having the first number of dimensions, wherein the first middle layer comprises at least one of a batch normalization (BN) layer or a rectified linear unit (ReLU) layer; and a second fully connected layer that receives the third output and produces a fourth output having a second number of dimensions that is greater than the first number of dimensions.

Aspect 32: The method of Aspect 31, wherein the temporal processing block comprises: a third fully connected layer that receives the encoded data set and produces a fifth output having the first number of dimensions; a second middle layer that receives the fifth output and produces a sixth output having the first number of dimensions, wherein the second middle layer comprises at least one of a BN layer or a ReLU layer; and a fourth fully connected layer that receives the sixth output and produces a seventh output having the first number of dimensions.

Aspect 33: The method of Aspect 32, wherein the temporal processing block further comprises a BN layer that receives the seventh output and produces an eighth output having the second number of dimensions, wherein the eighth output comprises an input to the RNN bank.

Aspect 34: The method of any of Aspects 27-33, wherein the RNN bank is configured to select one or more dimensions of a set of dimensions to use as input based at least in part on a correlation between the one or more dimensions and at least one additional dimension of the set of dimensions.

Aspect 35: The method of any of Aspects 27-34, wherein the RNN bank comprises a plurality of RNNs, each RNN of the plurality of RNNs corresponding to a different dimension of a plurality of dimensions.

Aspect 36: An apparatus for wireless communication at a device, comprising a processor; memory coupled with the processor; and instructions stored in the memory and executable by the processor to cause the apparatus to perform the method of one or more Aspects of Aspects 1-19.

Aspect 37: A device for wireless communication, comprising a memory and one or more processors coupled to the memory, the memory and the one or more processors configured to perform the method of one or more Aspects of Aspects 1-19.

Aspect 38: An apparatus for wireless communication, comprising at least one means for performing the method of one or more Aspects of Aspects 1-19.

Aspect 39: A non-transitory computer-readable medium storing code for wireless communication, the code comprising instructions executable by a processor to perform the method of one or more Aspects of Aspects 1-19.

Aspect 40: A non-transitory computer-readable medium storing a set of instructions for wireless communication, the set of instructions comprising one or more instructions that, when executed by one or more processors of a device, cause the device to perform the method of one or more Aspects of Aspects 1-19.

Aspect 41: An apparatus for wireless communication at a device, comprising a processor; memory coupled with the processor; and instructions stored in the memory and executable by the processor to cause the apparatus to perform the method of one or more Aspects of Aspects 20-35.

Aspect 42: A device for wireless communication, comprising a memory and one or more processors coupled to the memory, the memory and the one or more processors configured to perform the method of one or more Aspects of Aspects 20-35.

Aspect 43: An apparatus for wireless communication, comprising at least one means for performing the method of one or more Aspects of Aspects 20-35.

Aspect 44: A non-transitory computer-readable medium storing code for wireless communication, the code comprising instructions executable by a processor to perform the method of one or more Aspects of Aspects 20-35.

Aspect 45: A non-transitory computer-readable medium storing a set of instructions for wireless communication, the set of instructions comprising one or more instructions that, when executed by one or more processors of a device, cause the device to perform the method of one or more Aspects of Aspects 20-35.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A transmitting wireless communication device for wireless communication, comprising:
a memory; and
one or more processors, operatively coupled to the memory, configured to:
encode a data set using a single shot encoding operation and a temporal processing operation associated with at least one neural network to produce an encoded data set, wherein a dimensionality of a subset of inputs of a set of inputs to the temporal processing operation is greater than a dimensionality of the encoded data set; and
transmit the encoded data set to a receiving wireless communication device.

2. The transmitting wireless communication device of claim 1, wherein the data set is based at least in part on sampling of one or more reference signals.

3. The transmitting wireless communication device of claim 1, wherein the one or more processors, to transmit the encoded data set to the receiving wireless communication device, are configured to:
transmit channel state information feedback to the receiving wireless communication device.

4. The transmitting wireless communication device of claim 1, wherein the subset of inputs of the set of inputs to the temporal processing operation comprises a state vector that represents an output of a prior temporal processing operation.

5. The transmitting wireless communication device of claim 4, wherein the set of inputs to the temporal processing operation further comprises an output of the single shot encoding operation, and wherein a dimensionality of the state vector is greater than a dimensionality of the output of the single shot encoding operation.

6. The transmitting wireless communication device of claim 4, wherein the prior temporal processing operation is associated with an encoder of the transmitting wireless communication device.

7. The transmitting wireless communication device of claim 4, wherein the prior temporal processing operation is associated with a decoder of the receiving wireless communication device.

8. The transmitting wireless communication device of claim 1, wherein the one or more processors, to encode the data set using the temporal processing operation, are configured to perform the temporal processing operation using a temporal processing block.

9. The transmitting wireless communication device of claim 8, wherein the temporal processing block comprises a recurrent neural network (RNN) bank that includes one or more RNNs.

10. The transmitting wireless communication device of claim 9, wherein the one or more RNNs include at least one of:
a long-short term memory,
a gated recurrent unit, or
a basic RNN.

11. The transmitting wireless communication device of claim 8, wherein the temporal processing block comprises an output generator that includes at least one of:
a fully connected layer,
a convolutional layer, or
a fully connected convolutional layer.

12. The transmitting wireless communication device of claim 11, wherein the output generator takes, as input, an output of a recurrent neural network (RNN) bank and produces the encoded data set.

13. The transmitting wireless communication device of claim 12, wherein the output of the RNN bank comprises a state vector associated with a first time, and wherein the output generator takes, as additional input, an output of a single-shot encoder associated with a second time, wherein the second time occurs after the first time.

14. The transmitting wireless communication device of claim 13, wherein the output generator comprises:
a first fully connected layer that produces a first output having a first number of dimensions;
a rectified linear unit (ReLU) activation layer that receives the first output and produces a second output having the first number of dimensions; and
a second fully connected layer that receives the second output and produces a third output having a second number of dimensions that is less than the first number of dimensions.

15. The transmitting wireless communication device of claim 12, wherein an input of the RNN bank comprises a state vector associated with a first time, wherein the output of the RNN bank comprises a state vector associated with a second time, and wherein the output generator takes, as additional input, an output of a single-shot encoder associated with the second time, wherein the second time occurs after the first time.

16. The transmitting wireless communication device of claim 15, wherein the output generator comprises:
a first fully connected layer that produces a first output having a first number of dimensions;
a first batch normalization (BN) and rectified linear unit (ReLU) activation layer that receives the first output and produces a second output having the first number of dimensions; and
a second fully connected layer that receives the second output and produces a third output having a second number of dimensions that is less than the first number of dimensions.

17. The transmitting wireless communication device of claim 16, wherein the output generator further comprises a second BN layer that receives the third output and produces a fourth output having the second number of dimensions.

18. The transmitting wireless communication device of claim 9, wherein the RNN bank is configured to select one or more dimensions of a set of dimensions for an input to have based at least in part on a correlation between the one or more dimensions and at least one additional dimension of the set of dimensions.

19. The transmitting wireless communication device of claim 9, wherein the RNN bank comprises a plurality of RNNs, each RNN of the plurality of RNNs corresponding to a different dimension of a plurality of dimensions.

20. A receiving wireless communication device for wireless communication, comprising:
a memory; and
one or more processors, operatively coupled to the memory, configured to:
receive an encoded data set from a transmitting wireless communication device; and
decode the encoded data set using a single shot decoding operation and a temporal processing operation associated with at least one neural network to produce a decoded data set, wherein a dimensionality of a subset of inputs of a set of inputs to the temporal processing operation is less than a dimensionality of the decoded data set.

21. The receiving wireless communication device of claim 20, wherein the one or more processors, to receive the encoded data set from the transmitting wireless communication device, are configured to:
receive channel state information feedback from the transmitting wireless communication device.

22. The receiving wireless communication device of claim 20, wherein the subset of inputs of the set of inputs to the temporal processing operation comprises a state vector that represents an output of a prior temporal processing operation.

23. The receiving wireless communication device of claim 22, wherein an output of the temporal processing operation comprises an input to the single shot decoding operation, and wherein a dimensionality of the state vector is less than a dimensionality of the input to the single shot decoding operation.

24. The receiving wireless communication device of claim 20, wherein the one or more processors, to decode the encoded data set using the temporal processing operation, are configured to perform the temporal processing operation using a temporal processing block, wherein the temporal processing block comprises:
a recurrent neural network (RNN) bank that includes one or more RNNs, wherein an input of the RNN bank comprises a state vector associated with a first time, and wherein an output of the RNN bank comprises a state vector associated with a second time; and
an output generator that takes, as input, an output of the RNN bank and produces the decoded data set.

25. The receiving wireless communication device of claim 24, wherein the RNN bank produces a first output having a first number of dimensions, and wherein the output generator comprises:
a first fully connected layer that receives the first output and produces a second output having the first number of dimensions;
a first middle layer that receives the second output and produces a third output having the first number of dimensions, wherein the first middle layer comprises at least one of a batch normalization (BN) layer or a rectified linear unit (ReLU) layer; and
a second fully connected layer that receives the third output and produces a fourth output having a second number of dimensions that is greater than the first number of dimensions.

26. The receiving wireless communication device of claim 25, wherein the temporal processing block comprises:
a third fully connected layer that receives the encoded data set and produces a fifth output having the first number of dimensions;
a second middle layer that receives the fifth output and produces a sixth output having the first number of dimensions, wherein the second middle layer comprises at least one of a BN layer or a ReLU layer; and
a fourth fully connected layer that receives the sixth output and produces a seventh output having the first number of dimensions.

27. The receiving wireless communication device of claim 26, wherein the temporal processing block further comprises a BN layer that receives the seventh output and produces an eighth output having the second number of dimensions, wherein the eighth output comprises an input to the RNN bank.

28. The receiving wireless communication device of claim 25, wherein the RNN bank is configured to select one or more dimensions of a set of dimensions to use as input based at least in part on a correlation between the one or more dimensions and at least one additional dimension of the set of dimensions.

29. A method of wireless communication performed by a transmitting wireless communication device, comprising:
encoding a data set using a single shot encoding operation and a temporal processing operation associated with at least one neural network to produce an encoded data set, wherein a dimensionality of a subset of inputs of a set of inputs to the temporal processing operation is greater than a dimensionality of the encoded data set; and
transmitting the encoded data set to a receiving wireless communication device.

30. A method of wireless communication performed by a receiving wireless communication device, comprising:
receiving an encoded data set from a transmitting wireless communication device; and
decoding the encoded data set using a single shot decoding operation and a temporal processing operation associated with at least one neural network to produce a decoded data set, wherein a dimensionality of a subset of inputs of a set of inputs to the temporal processing operation is less than a dimensionality of the decoded data set.
